(19) United States
(12) Patent Application Publication
(10) Pub. No.: US 2008/0147593 A1
(43) Pub. Date: Jun. 19, 2008

(54) RUNTIME RESOURCE SENSITIVE AND DATA DRIVEN OPTIMIZATION

(76) Inventors: Bhashyam Ramesh, Secunderabad (IN); Olli Pekka Kostamaa, Santa Monica, CA (US)

Correspondence Address: JAMES M. STOVER;TERADATA CORPORATION, 2835 MIAMI VILLAGE DRIVE, MIAMISBURG, OH, 45342, US

(21) Appl. No.: 11/610,544

(22) Filed: Dec. 14, 2006

(51) Int. Cl. G06F 7/06

(52) U.S. Cl. 707/2; 707/E17.017

(57) ABSTRACT

A technique for generating two or more execution plans for an SQL query within a database system. The system has two or more resources. A first resource utilization profile is defined by associating a first set of numerical utilization values respectively with two or more of the resources. The utilization values represent utilization of the resources. A first execution plan is generated that is optimal assuming utilization of the resources specified in the first resource utilization profile. The technique defines at least one further resource utilization profile by associating at least one further set of numerical utilization values respectively with two or more of the resources, the further utilization values representing utilization of the resources. At least one further execution plan is generated that is optimal assuming utilization of the resources specified in the further resource utilization profile(s).

### BACKGROUND

Typical database systems receive queries to retrieve information from data sources managed by the database system. In a relational database system these data sources are typically organized into a series of tables. Queries are received in a standard format such as SQL.

Most databases use an optimizer that attempts to generate an optimal query execution plan. Execution of a query uses system resources such as for example CPU usage and I/O count. Many optimizers generate an optimal query execution plan on the assumption that all resources of the database system are available during query execution time.

Many times this assumption is incorrect, especially for queries running in a production data warehouse environment. The optimal plan for these systems depends on the current workload of the system. This workload, especially during busy times of the processing day, typically is resource constrained at one of the major resources. Since these resource constraints can change, the assumption of a query having uncontested access to all the available resources is often incorrect.

Depending on the availability of the resources, different plans can produce significantly better execution times and overall system throughput.

Described below is a technique for generating two or more execution plans for an SQL query within a database system. The system has two or more resources. A first resource utilization profile is defined by associating a first set of numerical utilization values respectively with two or more of the resources. The utilization values represent utilization of the resources. A first execution plan is generated that is optimal assuming utilization of the resources specified in the first resource utilization profile. The technique defines at least one further resource utilization profile by associating at least one further set of numerical utilization values respectively with two or more of the resources, the further utilization values representing utilization of the resources. At least one further execution plan is generated that is optimal assuming utilization of the resources specified in the further resource utilization profile(s).

Also described below is a method of selecting for use a stored execution plan for an SQL query within a database system. The system has two or more resources. Respective current resource utilization values are defined for two or more of the resources. The resource utilization values represent utilization of the resources. A plurality of execution plans are maintained for the SQL query. The plans have associated plan resource utilization values. The current resource utilization values are compared with the plan resource utilization values. One of the maintained execution plans is selected based at least partly on the result of the comparison.

### BRIEF DESCRIPTION OF THE DRAWINGS

FIG. 1 is a block diagram of an exemplary large computer system in which the techniques described below are implemented.

FIG. 2 is a block diagram of the parsing engine of the computer system of FIG. 1.

FIG. 3 is a flowchart of the parser of FIG. 2.

FIG. 4 shows an example decision matrix.

FIG. 5 shows a populated decision matrix.

FIG. 6 is a sample table showing the relationship between resource utilization values and RVI values.

FIG. 7 shows example system utilization values at query run time.

### DETAILED DESCRIPTION

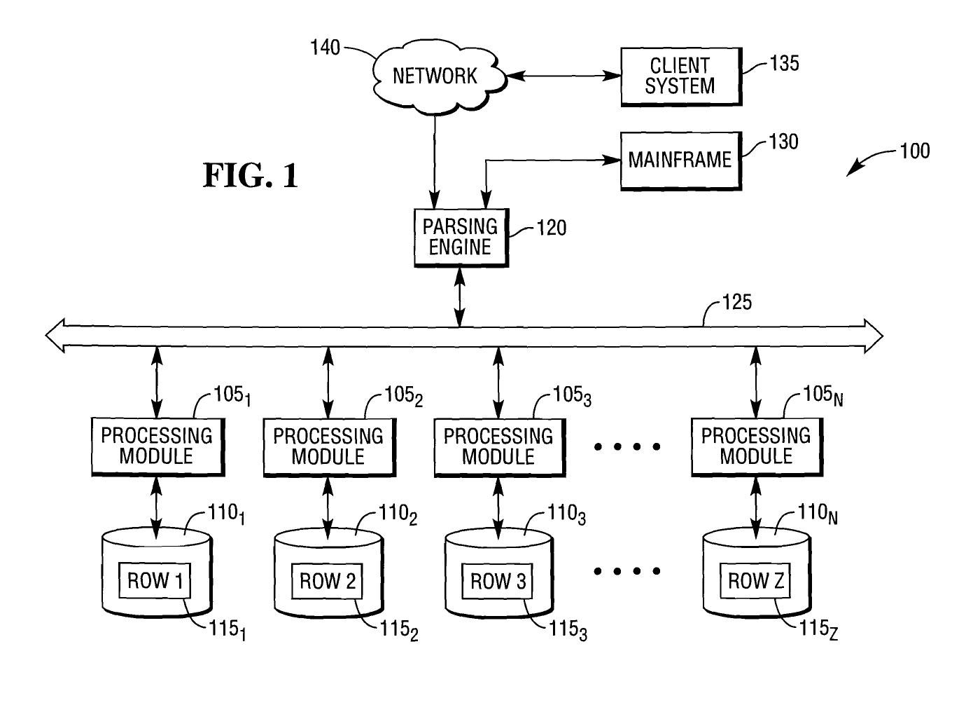

FIG. 1 shows an example of a database system 100, such as a Teradata active data warehousing system available from NCR Corporation. Database system 100 is an example of one type of computer system in which the techniques of managing run time optimization of queries are implemented. In computer system 100, vast amounts of data are stored on many disk-storage facilities that are managed by many processing units. In this example, the data warehouse 100 includes a relational database management system (RDBMS) built upon a massively parallel processing (MPP) platform.

Other types of database systems, such as object-relational database management systems (ORDMS) or those built on symmetric multi-processing (SMP) platforms are also suited for use here.

The data warehouse 100 includes one or more processing modules 105_{1 . . . N} that manage the storage and retrieval of data in data-storage facilities 110_{1 . . . N}. Each of the processing modules 105_{1 . . . N} manages a portion of a database that is stored in a corresponding one of the data-storage facilities 110_{1 . . . N}. Each of the data-storage facilities 110_{1 . . . N} includes one or more disk drives.

The system stores data in one or more tables in the data-storage facilities 110_{1 . . . N}. The rows 115_{1 . . . Z} of the tables are stored across multiple data-storage facilities 110_{1 . . . N} to ensure that the system workload is distributed evenly across the processing modules 105_{1 . . . N}. A parsing engine 120 organizes the storage of data and the distribution of table rows 115_{1 . . . Z} among the processing modules 105_{1 . . . N}. The parsing engine 120 also coordinates the retrieval of data from the data-storage facilities 110_{1 . . . N} over network 125 in response to queries received from a user at a mainframe 130 or a client computer 135 connected to a network 140. The database system 100 usually receives queries and commands to build tables in a standard format, such as SQL.

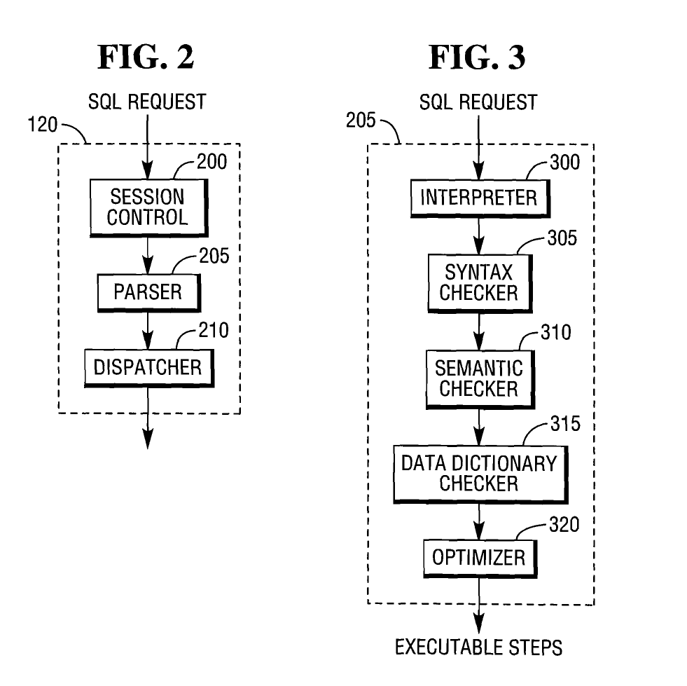

In one example system shown in FIG. 2, the parsing engine 120 is made up of three components: a session control 200, a parser 205, and a dispatcher 210. The session control 200 provides a log on and log off function. It accepts a request for authorization to access the database, verifies it, and then either allows or disallows the access. Once the session control 200 allows a session to begin, a user may submit an SQL request, which is routed to the parser 205.

As illustrated in FIG. 3, the parser 205 interprets the SQL request (block 300), checks it for a proper SQL syntax (block 305), evaluates it semantically (block 310), and consults a data dictionary to ensure that all of the objects specified in the SQL request actually exist and the user has the authority to perform the request (block 315).

Finally, the parser 205 runs an optimizer (block 320). Optimizer 320 attempts to generate an optimal query execution plan. Whether or not a plan is optimal will depend on the current consumption of two or more resources included in the database system. One of these resources is CPU usage, another resource is available memory, another resource is network usage and a further resource is I/O count.

As will be described below, the optimizer generates two or more different execution plans. Each of the plans is optimal given different resource utilization profiles. Each resource utilization profile defines a different set of actual expected run time resource availabilities.

The optimizer generates different plans, each plan appropriate for a different set of actual run time resource availabilities. The appropriate plan is chosen for execution by considering the actual resources available at the instance when the plan is ready to be dispatched for execution.

One example is where an optimizer considers memory as one important resource. The optimizer would generate two different plans, plan A and plan B.

Plan A is generated by the optimizer assuming that x MB of memory is available. Plan B is also generated by the optimizer assuming that less than x MB of memory is available.

The decision to use plan A or plan B is made at execution time using a rule such as the following:

if there is x MB of memory available then use plan A else use plan B.

In practice a complicated system will have two or more and usually several resources under consideration. The optimizer defines a first resource utilization profile that associates a first set of numerical utilization values respectively with two or more of the resources, the utilization values representing utilization of the resources. The optimizer also defines at least one further resource utilization profile by associating at least one further set of numerical utilization values respectively with two or more of the resources, the further utilization values representing utilization of the resources.

Where there are several utilization profiles, one preferred form technique of the optimizer is to generate a decision matrix. At run time, the plan closest to the actual current system resource profile is chosen from the matrix. An important feature of the technique is that the choice as to which plan to select is made at the time of execution. This is especially important in systems where the parsing and execution of queries occurs at different points in time. This is true of almost all systems that parse and optimize a query to determine an execution mechanism.

In one technique, each resource of the database system is assigned a numerical utilization value.

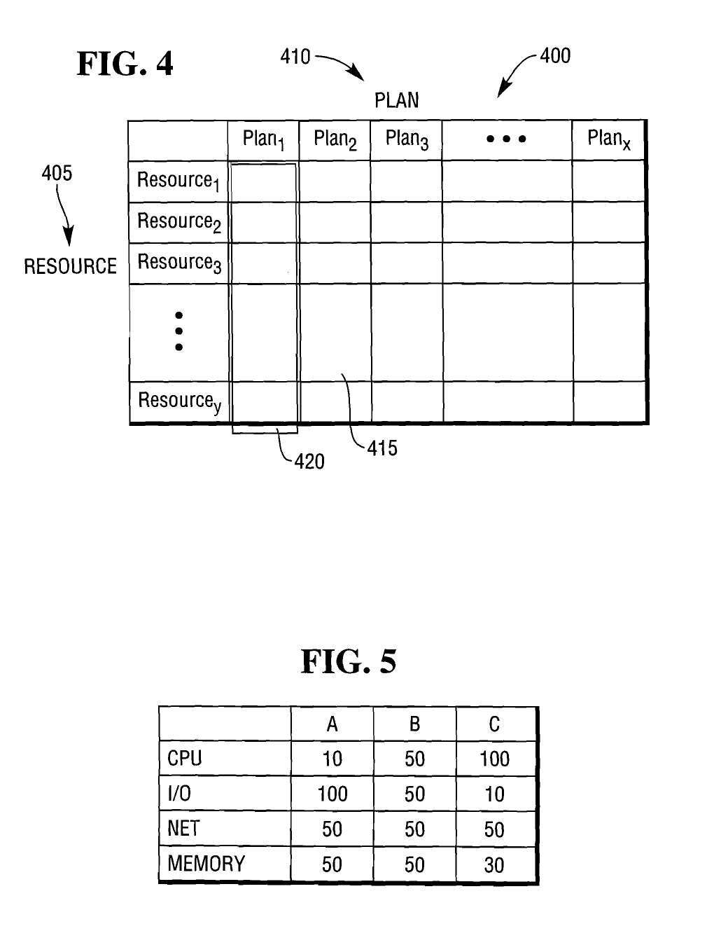

FIG. 4 shows an example of a decision matrix 400. The matrix 400 shows a series of different resources 405 specified as resource_{1 . . . Y}. The matrix also shows a series of plans 410 for example plan_{1 . . . X}. Matrix 400 includes a plurality of cells one of which is indicated at 415. Each cell is populated with a numerical utilization value. A resource utilization profile 420 is a set of numerical utilization values associated respectively with each of resources_{1 . . . Y}. The optimizer generates different plans based on the different resource utilization profiles. Each resource utilization profile represents a different assumption of resource utilizations.

FIG. 5 shows a populated decision matrix 500. The matrix 500 shows four different resources namely CPU usage 505, I/O count 510, network usage 515, and available memory 520. It is envisaged that further possible resources are anticipated such as memory caches and storage device type. Memory caches have several levels or hierarchies leading to optimization decisions. Similarly, storage devices can be fast or slow which leads to optimization decisions. The four shown in FIG. 5 are byway of example.

As shown in FIG. 5, the utilization values are in the range 0 to 100. Each resource is assigned a utilization value in this range. A value of 0 means that the resource is heavily utilized and 100 means the resource is not utilized. Values in between 0 and 100 indicate the extent of utilization of that resource. The optimizer generates plans for different resource utilization profiles by assuming different utilizations for the different resources. As shown in FIG. 5, three different plans are generated, plan A, plan B and plan C Each of the plans is generated on the assumption of a different resource utilization profile.

A utilization value of 10 in the matrix 500 indicates an assumption that ten percent of the resource is available. Similarly, a value of 30 indicates 30 percent of resource available. A value of 100 indicates that 100 percent of the resource is available.

In matrix 500, plan A would be chosen when the run time system is heavily CPU bound. Where there is heavy CPU usage, a plan that assumes only ten percent of the CPU resource is available would be preferred over other plans that assume a greater percentage of CPU resource is available.

Similarly, plan C shown in matrix 500 would be chosen at times when the run time system is heavily I/O bound as plan C assumes only ten percent of I/O is available. Plan B in matrix 500 would be chosen when the system resource use is balanced. This assumes that each of resources 505, 510, 515 and 520 are each approximately fifty percent utilized.

The numerical utilization values making up each resource profile could be generated by the optimizer or could be user defined. For example, in one form the optimizer generated profiles are based on the optimizer's assumption of resource availabilities, while performing the query optimization. The user can override these values, for cases where certain types of plans are preferred. This could be the case for low priority queries that should not utilize too much of a known bottleneck resource.

In some cases different resource profiles will generate the same plan. This will happen more often with simple queries where there are fewer choices of plans.

Once the plans have been defined it is then necessary to select one of the stored execution plans to satisfy the SQL query. The choice of plan is made at run time. The first step is to define respective current resource utilization values for two or more of the resources.

In one technique, the current utilization of one or more of the resources is computed for the past n seconds. The value of n is called the SYSTEM REACTION TIME (SRI). The value of n is predefined and is small when it is desired to have a fast reacting run time system. Alternatively the value of n can be selected as a large number for a slow reacting run time system. It is envisaged that the value of n is initially set at a default value of between 1 second and 60 seconds. The value is able to be adjusted by a system administrator.

A resource index value (RVI) is then assigned to one or more of the resources. For example, if the utilization value of a resource is between 0 and 10 percent during the system reaction time (SRT), then that resource is assigned a resource index value (RVI) of 100. If the utilization value is between 91 and 100 during the system reaction time (SRT) then that resource is assigned a resource index value (RVI) of 10.

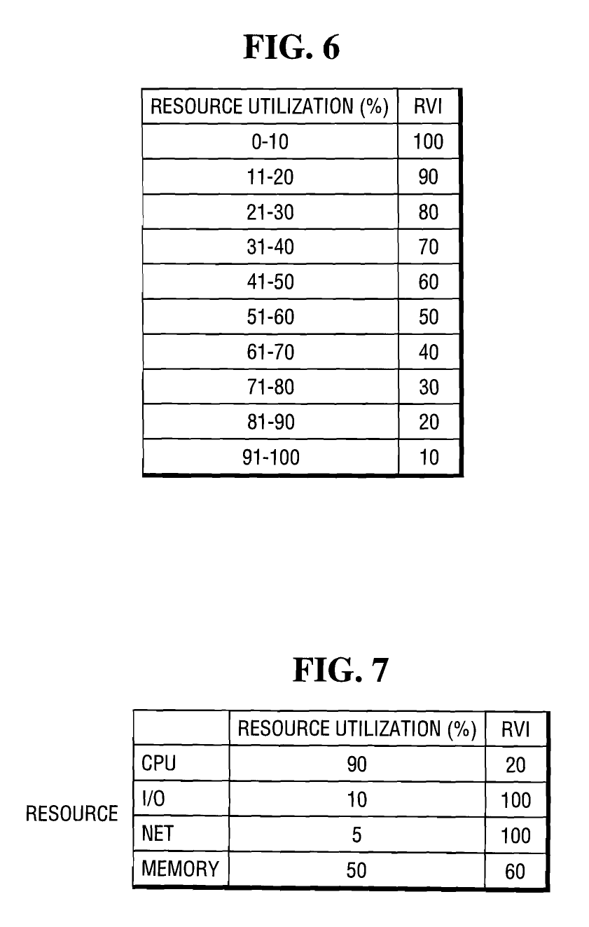

FIG. 6 shows a sample table indicating one method of assigning current resource utilization values based on current utilization. Examples shown in FIG. 6 show a simple uniform distribution. It is anticipated that the relationship of resource utilization to RVI may follow other distribution curves having varying skewness and kurtosis coefficients.

It will be clear from FIG. 6 that there is an inverse relationship between resource utilization and RVI. A low resource utilization value maps to a high RVI value whereas a high resource utilization value maps to a low RVI value.

The next step is to compare the current resource utilization values, for example the RVI values, with the plan resource utilization values shown and described above. One example of the comparison step includes a calculation such as:

$$Sum ( {Plan}_{x} ) = abs ( {RVI}_{1} - {RUV}_{1} ) + abs ( {RVI}_{2} - {RUV}_{2} ) + … abs ( {RVI}_{Y} - {RUV}_{Y} )$$

In the equation above, RUV₁ is the resource utilization value for a first resource in the matrix and RVI₁ is the calculated resource index value for that first resource. The respective absolute differences between the respective RVI and RUV values are calculated and summed to generate a cost for an individual plan.

One of the plans is then selected based at least partly on this comparison between resource index values and resource utilization values. In one example the plan with the smallest calculated cost from the equation above is chosen for execution. This is based on an assumption that all resources forming part of the calculation are equally important.

Depending on the amount of the available optimization time, the optimizer is able to generate multiple plans for evaluation at run time, each plan generated assuming a different resource utilization profile.

Assuming a decision matrix such as that shown in FIG. 5, it is assumed that at query run time the system utilization values for the four resources are that shown in FIG. 7. The resources CPU, I/O, network, and memory have resource utilization percentages of 90, 10, 5 and 50 respectively. RVI values are calculated from these resource utilization percentages using the distribution table shown in FIG. 6.

The cost or sum of each of plans A, B and C is calculated as follows:

$$\begin{matrix}SUM ( Plan A ) = abs ( CPU ( RVI ) - CPU ( Plan A ) ) + \\ abs ( IO ( RVI ) - IO ( Plan A ) ) + \\ abs ( Net ( RVI ) - Net ( Plan A ) ) + \\ abs ( Memory ( RVI ) - Memory ( Plan A ) ) \\ = abs ( 20 - 10 ) + abs ( 100 - 100 ) + abs ( 100 - 50 ) + \\ abs ( 60 - 50 ) \\ = 70\end{matrix}$$

$$\begin{matrix}SUM ( Plan B ) = abs ( 20 - 50 ) + abs ( 100 - 50 ) + abs ( 100 - 50 ) + \\ abs ( 60 - 50 ) \\ = 140\end{matrix}$$

$$\begin{matrix}SUM ( Plan C ) = abs ( 20 - 100 ) + abs ( 100 - 10 ) + abs ( 100 - 50 ) + \\ abs ( 60 - 30 ) \\ = 250\end{matrix}$$

The calculated cost for plan A is 70, the calculated cost for plan B is 140 and the calculated cost for plan C is 250. Since the sum for plan A is the lowest, this plan will generally be selected as the plan to execute given the current resource utilization shown in FIG. 7.

It will be appreciated that in a variation of the above technique a low utilization value could instead signal low utilization and hence high availability. A high utilization value would signal high utilization and hence low availability. RVI values would have an inverse relationship with utilization.

The text above describes one or more specific embodiments of a broader invention. The invention also is carried out in a variety of alternative embodiments and thus is not limited to those described here. Those other embodiments are also within the scope of the following claims.

We claim:

1. A method of generating two or more execution plans for an SQL query within a database system, the system having two or more resources, the method comprising the steps of:
defining a first resource utilization profile by associating a first set of numerical utilization values respectively with two or more of the resources, the utilization values representing utilization of the resources;
generating a first execution plan that is optimal assuming utilization of the resources specified in the first resource utilization profile;
defining at least one further resource utilization profile by associating at least one further set of numerical utilization values respectively with two or more of the resources, the further utilization values representing utilization of the resources;
generating at least one further execution plan that is optimal assuming utilization of the resources specified in the at least one further resource utilization profile.

2. The method of claim 1 wherein the resources include CPU usage, I/O count, network usage and available memory.

3. The method of claim 1 wherein the numerical utilization values are in the range 0 to 100.

4. The method of claim 3 wherein a numerical utilization value of 0 represents low utilization and a numerical utilization value of 100 represents high utilization.

5. The method of claim 1 wherein the first and the at least one further resource utilization profiles represent at least one optimization goal.

6. The method of claim 5 wherein the at least one optimization goal includes minimum query response time.

7. The method of claim 5 wherein the at least one optimization goal includes maximum throughput.

8. The method of claim 5 wherein a user specifies the at least one optimization goal when submitting the SQL query.

9. A method of selecting for use a stored execution plan for an SQL query within a database system, the system having two or more resources, the method comprising the steps of:
defining respective current resource utilization values for two or more of the resources, the resource utilization values representing utilization of the resources;
maintaining a plurality of execution plans for the SQL query, the plans having associated plan resource utilization values;
comparing the current resource utilization values with the plan resource utilization values;
selecting one of the maintained execution plans based at least partly on the result of the comparison

10. The method of claim 9 wherein the step of defining respective current resource utilization values further comprises the steps of:
calculating respective historical resource utilization values for the two or more resources, for a predefined prior interval; and
calculating the current resource utilization values at least partly from the historical resource utilization values.

11. The method of claim 9 wherein the step of comparing the current resource utilization values with the plan resource utilization values further comprises the steps of:
calculating the absolute difference(s) between pairs of current resource utilization values and plan resource utilization values; and
calculating the sum of the calculated absolute differences.

12. The method of claim 11 wherein the current resource utilization values and plan resource utilization values are in the range 0 to 100.

13. The method of claim 12 wherein a historical utilization value of 0 represents low availability of the resource, and a historical utilization value of 100 represents high availability of the resource.

14. The method of claim 13 wherein a plan utilization value of 0 represents low usage of the resource, and a plan utilization value of 100 represents high usage of the resource.

15. The method of claim 14 wherein the selected plan has the lowest calculated sum of calculated absolute differences.
